(19) United States
(12) Patent Application Publication
(10) Pub. No.: US 2024/0347769 A1
(43) Pub. Date: Oct. 17, 2024

(54) ALL-SOLID-STATE BATTERY

(71) Applicant: TDK CORPORATION, Tokyo (JP)

(72) Inventor: Shinya WATANABE, Tokyo (JP)

(73) Assignee: TDK CORPORATION, Tokyo (JP)

(21) Appl. No.: 18/682,316

(22) PCT Filed: Aug. 5, 2022
(86) PCT No.: PCT/JP2022/030103

§ 371 Date: Feb. 8, 2024

(30) Foreign Application Priority Data
Aug. 12, 2021 (JP) 2021-131626

(51) Int. Cl. H01M 10/0565; H01M 4/131; H01M 4/86; H01M 10/052

(52) U.S. Cl. CPC H01M 10/0565; H01M 4/131; H01M 10/052; H01M 2004/8684

(57) ABSTRACT

An all-solid-state battery includes: a laminate in which a positive electrode active material layer, a solid electrolyte layer, and a negative electrode active material layer are laminated in this order; a positive electrode current collector and a negative electrode current collector which sandwich the laminate in a laminating direction; an insulating sheet which surrounds the laminate between the positive electrode current collector and the negative electrode current collector; and a first adhesive sheet which bonds the insulating sheet and the positive electrode current collector or the insulating sheet and the negative electrode current collector, wherein a first through-hole is formed in the first adhesive sheet and the laminate is accommodated in the first through-hole when viewed from the laminating direction of the laminate.

### TECHNICAL FIELD

The present invention relates to an all-solid-state battery.

Priority is claimed on Japanese Patent Application No. 2021-131626, filed on Aug. 12, 2021, the content of which is incorporated herein by reference.

### BACKGROUND ART

In recent years, electronics technology has made remarkable progress, and portable electronic devices are becoming smaller, lighter, thinner, and more multifunctional. Along with this, there is a strong desire for batteries that serve as power sources for electronic devices to be smaller, lighter, thinner, and more reliable. Under these circumstances, all-solid-state batteries that use a solid electrolyte as an electrolyte as disclosed in Patent Documents 1 to 3 are attracting attention.

The all-solid-state battery disclosed in Patent Document 1 discloses that a tape-shaped insulator is used at an edge portion of a current collector foil in order to suppress short circuits. In the all-solid-state battery disclosed in Patent Document 1, the outer shape of the current collector foil is larger than the outer shape of the solid electrolyte layer and short circuits may occur when the current collector foils come into contact with each other.

The all-solid-state battery disclosed in Patent Document 2 includes a positive electrode active material layer, a solid electrolyte layer, a negative electrode active material layer, and a current collector plate that sandwiches them in a laminating direction and a cylindrical insulating frame is disposed to be in close contact with a side surface of the current collector plate. The cylindrical insulating frame is used to manufacture the all-solid-state battery, materials of the positive electrode layer, the negative electrode layer, and the solid electrolyte layer are accommodated inside the cylindrical insulating frame, and these materials are pressed in a laminating direction to manufacture the all-solid-state battery. At this time, Patent Document 2 discloses that the materials of the positive electrode layer and the negative electrode layer enter between the insulating frame and the current collector plate located at the end in the laminating direction and the airtightness between the current collector plate and the insulating frame is ensured.

In the all-solid-state battery disclosed in Patent Document 3, side surfaces of a positive electrode layer, a negative electrode layer, and a solid electrolyte layer are covered with a resin layer.

### CITATION LIST

### Patent Literature

[Patent Document 1] Japanese Unexamined Patent Application, First Publication No. 2004-134116
[Patent Document 2] Japanese Unexamined Patent Application, First Publication No. 2011-159635
[Patent Document 3] Japanese Unexamined Patent Application, First Publication No. 2019-192610

### SUMMARY OF INVENTION

### Technical Problem

However, in the method of using the tape-shaped insulator at the edge portion of the current collector foil disclosed in Patent Document 1, the laminate including the positive electrode active material layer, the solid electrolyte layer, and the negative electrode active material layer may be shifted in the in-plane direction or short circuits may occur in a region closer to the laminate than the insulator.

Further, in the all-solid-state batteries disclosed in Patent Document 2 and Patent Document 3, cracking of the laminate may occur. Further, in the all-solid-state batteries disclosed in Patent Document 2 and Patent Document 3, since it requires a process of covering the all-solid-state battery with an insulating film, production efficiency is low. Further, even if a slight problem occurs, it is difficult to perform operations such as removing the coating, and the all-solid-state batteries disclosed in Patent Document 2 and Patent Document 3 have low versatility.

The present invention has been made in view of the above-described circumstances and an object thereof is to provide an all-solid-state battery capable of suppressing misalignment, cracking, and short circuits of a laminate and having a low internal resistance.

### Solution to Problem

An all-solid-state battery according to a first aspect of the present invention includes: a laminate in which a positive electrode active material layer, a solid electrolyte layer, and a negative electrode active material layer are laminated in this order; a positive electrode current collector and a negative electrode current collector which sandwich the laminate in a laminating direction; an insulating sheet which surrounds the laminate between the positive electrode current collector and the negative electrode current collector; and a first adhesive sheet which bonds the insulating sheet and the positive electrode current collector or the insulating sheet and the negative electrode current collector, wherein a first through-hole is formed in the first adhesive sheet, and wherein the laminate is accommodated in the first through-hole when viewed from the laminating direction of the laminate.

### Advantageous Effects of Invention

According to the present invention, it is possible to provide the all-solid-state battery capable of suppressing the misalignment, cracking, and short circuits of the laminate and having a low internal resistance.

### BRIEF DESCRIPTION OF DRAWINGS

FIG. 1 is a perspective view of an all-solid-state battery according to a first embodiment of the present invention.

FIG. 2 is a cross-sectional view of the all-solid-state battery according to the first embodiment of the present invention.

FIG. 3 is a plan view of the all-solid-state battery according to the first embodiment of the present invention.

FIG. 4 is a cross-sectional view of an all-solid-state battery of Comparative Example showing an action of the present invention.

FIG. 5 is a plan view of the all-solid-state battery of Comparative Example showing an action of the present invention.

FIG. 6 is a plan view of an all-solid-state battery of Modified Example of the first embodiment of the present invention.

FIG. 7 is a plan view of the all-solid-state battery of Modified Example.

FIG. 8 is a plan view of the all-solid-state battery of Modified Example.

FIG. 9 is a plan view of the all-solid-state battery of Modified Example.

FIG. 10 is a cross-sectional view taken along a cut line A-A of FIG. 9.

FIG. 11 is a cross-sectional view of the all-solid-state battery of Modified Example.

FIG. 12 is a plan view of the all-solid-state battery shown in FIG. 11.

FIG. 13 is a cross-sectional view of the all-solid-state battery of Modified Example.

FIG. 14 is a cross-sectional view of the all-solid-state battery of Modified Example.

FIG. 15 is a cross-sectional view of the all-solid-state battery of Modified Example.

FIG. 16 is a plan view of the all-solid-state battery of Modified Example.

FIG. 17 is a cross-sectional view of the all-solid-state battery shown in FIG. 16.

FIG. 18 is a plan view of the all-solid-state battery of Modified Example.

FIG. 19A is a plan view of the all-solid-state battery of Modified Example.

FIG. 19B is a plan view of the all-solid-state battery of Modified Example.

FIG. 19C is a plan view of the all-solid-state battery of Modified Example.

FIG. 20 is a graph showing the measurement results of the internal resistance of Examples 1 and 2 and Comparative Example 1.

### DESCRIPTION OF EMBODIMENTS

The present invention includes the following aspects.

(1) An all-solid-state battery according to a first aspect of the present invention includes: a laminate in which a positive electrode active material layer, a solid electrolyte layer, and a negative electrode active material layer are laminated in this order; a positive electrode current collector and a negative electrode current collector which sandwich the laminate in a laminating direction; an insulating sheet which surrounds the laminate between the positive electrode current collector and the negative electrode current collector; and a first adhesive sheet which bonds the insulating sheet and the positive electrode current collector or the insulating sheet and the negative electrode current collector, wherein a first through-hole is formed in the first adhesive sheet, and wherein the laminate is accommodated in the first through-hole when viewed from the laminating direction of the laminate.

(2) The all-solid-state battery according to (1) may further include a second adhesive sheet and the second adhesive sheet may bond the insulating sheet and the positive electrode current collector or the insulating sheet and the negative electrode current collector in a surface opposite to a surface contacting the first adhesive sheet in the insulating sheet.

(3) In the all-solid-state battery according to (1) or (2), a gap between the positive electrode current collector and the negative electrode current collector in a region overlapping the first adhesive sheet may be smaller than a gap between the positive electrode current collector and the negative electrode current collector in a region overlapping the laminate.

(4) In the all-solid-state battery according to any one of (1) to (3), a second through-hole may be formed in the insulating sheet, the laminate may be accommodated in the second through-hole when viewed from the laminating direction of the laminate, and the first through-hole may have a shape similar or congruent with that of the second through-hole.

(5) In the all-solid-state battery according to any one of (1) to (4), a second through-hole may be formed in the insulating sheet, the laminate may be accommodated in the second through-hole when viewed from the laminating direction of the laminate, and an inner dimension of the first through-hole may be equal to or larger than an inner dimension of the second through-hole.

(6) The all-solid-state battery according to any one of (1) to (5) may further include an adhesive tape and the adhesive tape may include a first portion which contacts a surface on the side opposite to a surface contacting the laminate in the positive electrode current collector, a second portion which contacts a surface on the side opposite to a surface contacting the laminate in the negative electrode current collector, and a third portion which connects the first portion and the second portion.

Hereinafter, an example of the embodiment of the present invention will be described in detail with reference to the drawings. Furthermore, the drawings used in the following explanation may show characteristic parts enlarged for convenience in order to make the characteristics of the present invention easier to understand. The dimensional ratio, orientation, or the like of each component may differ from the actual one.

### <All-Solid-State Battery>

### First Embodiment

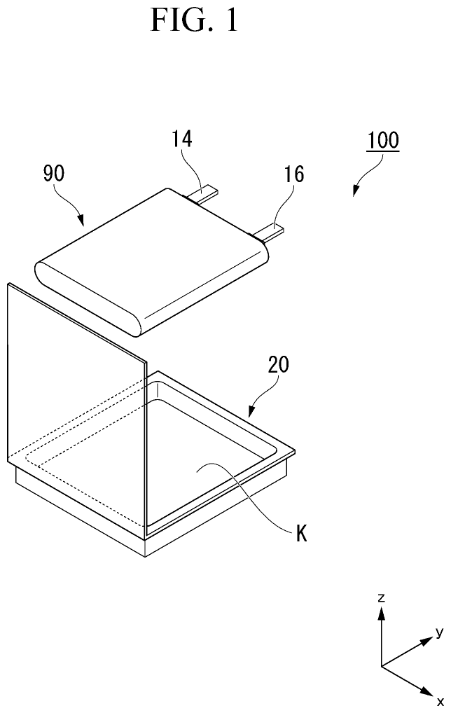

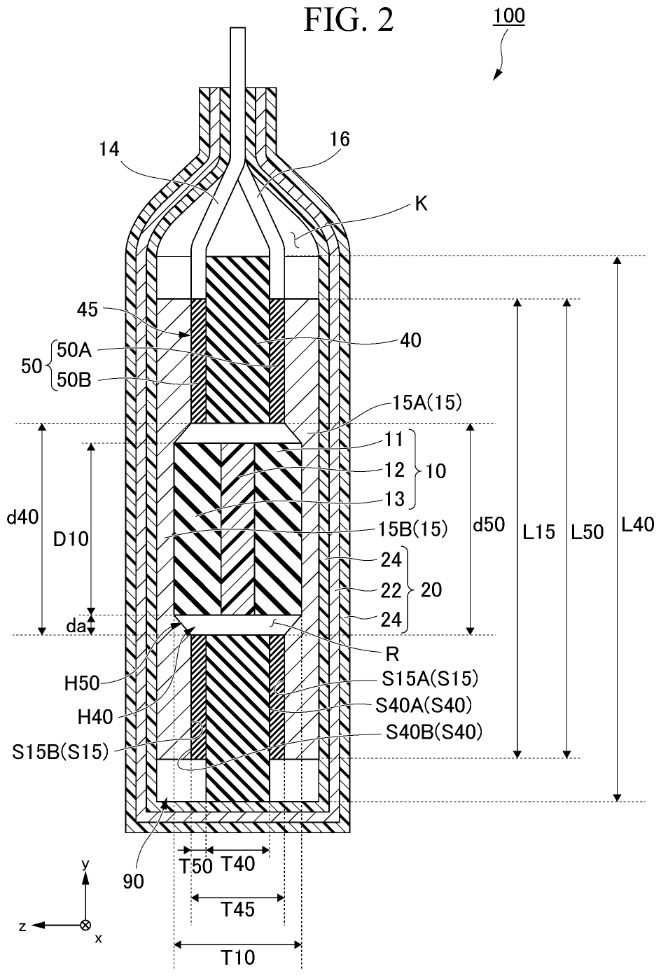

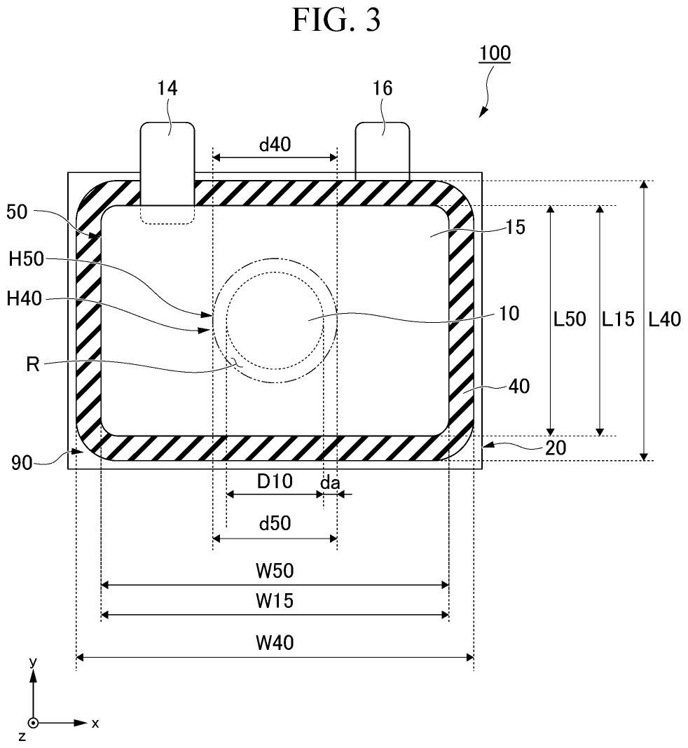

FIG. 1 is a perspective view of an all-solid-state battery 100 according to this embodiment. FIG. 2 is a cross-sectional view of the all-solid-state battery 100 according to this embodiment. FIG. 3 is a plan view of the all-solid-state battery 100 according to this embodiment. Furthermore, in FIG. 3, for convenience of explanation, an exterior body 20, which will be described later, is simplified.

The all-solid-state battery 100 includes the exterior body 20 and a power storage element 90 which is accommodated in a main space K inside the exterior body 20. FIG. 1 shows a state immediately before the power storage element 90 is accommodated in the exterior body 20 in order to facilitate understanding.

In this embodiment, a xyz orthogonal coordinate system is set to explain the positional relationship of each configuration. Hereinafter, the direction in which a laminate 10 is laminated is referred to as the z direction, one direction among the planes orthogonal to the z direction is referred to as the x direction, and the direction orthogonal to the z direction and the x direction is referred to as the y direction.

### {Exterior Body}

The exterior body 20 includes, for example, a metal foil 22 and resin layers 24 which are laminated on both surfaces of the metal foil 22 (see FIG. 2). The exterior body 20 is a metal laminate film in which the metal foil 22 is coated on both sides with a polymer film (resin layer). The metal foil 22 is, for example, an aluminum foil. The resin layer 24 is, for example, a polymer film such as polypropylene. The resin layer 24 may be different on the inside and outside. For example, the outer resin layer can be made of a polymer with a high melting point such as polyethylene terephthalate (PET) or polyamide (PA) and the inner resin layer can be made of a material with high heat resistance, oxidation resistance, and reduction resistance such as polyethylene (PE) and polypropylene (PP).

### {Power Storage Element}

The power storage element 90 includes the laminate 10, a positive electrode current collector 15A, a negative electrode current collector 15B, an insulating sheet 40, a first adhesive sheet 50A, and a second adhesive sheet 50B. Hereinafter, when the positive electrode current collector 15A and the negative electrode current collector 15B are not distinguished from each other, they may be simply referred to as the current collector 15. Hereinafter, when the first adhesive sheet 50A and the second adhesive sheet 50B are not distinguished from each other, they may be simply referred to as the adhesive sheet 50.

### [Current Collector]

Each of the positive electrode current collector 15A and the negative electrode current collector 15B spreads in the in-plane direction intersecting the z direction. The positive electrode current collector 15A and the negative electrode current collector 15B sandwich the laminate 10 in the z direction. In FIGS. 2 and 3, the width of the current collector 15 in the x direction is indicated by W15 and the length thereof in the y direction is indicated by L15.

The positive electrode current collector 15A and the negative electrode current collector 15B are made of, for example, a material with high conductivity. The positive electrode current collector 15A and the negative electrode current collector 15B are, for example, metals such as silver, palladium, gold, platinum, aluminum, copper, nickel, titanium, stainless steel, and alloys thereof or conductive resin. The positive electrode current collector 15A and the negative electrode current collector 15B may be made of the same material or different materials. Although FIGS. 2 and 3 show an example in which the positive electrode current collector 15A and the negative electrode current collector 15B have the same size, they may be different in size.

### [Laminate]

In the laminate 10, a positive electrode active material layer 11, a solid electrolyte layer 12, and a negative electrode active material layer 13 are laminated in this order in the z direction. The laminate 10 is disposed between the positive electrode current collector 15A and the negative electrode current collector 15B. The laminate 10 is accommodated in a second through-hole H40 and a first through-hole H50 to be described later in the in-plane direction of the positive electrode active material layer 11.

The planar shape of the laminate 10 is, for example, circular. In this embodiment, the outer dimension of the laminate 10 when viewed from above in the z direction is indicated by D10 and the thickness of the laminate 10 in the z direction is indicated by T10.

The laminate 10 exchanges electrons with the positive electrode current collector 15A and the negative electrode current collector 15B and exchanges lithium ions via the solid electrolyte layer 12. The all-solid-state battery 100 is charged or discharged when the laminate 10 exchanges electrons and lithium ions.

### (Positive Electrode Active Material Layer)

The positive electrode active material layer 11 is on the side of the positive electrode current collector 15A in the solid electrolyte layer 12. The positive electrode active material layer 11 contains a positive electrode active material and may also contain a conductive additive, a binder, and a solid electrolyte to be described later if necessary.

Examples of the positive electrode active materials contained in the positive electrode active material layer 11 include lithium-containing transition metal oxides, transition metal fluorides, polyanions, transition metal sulfides, transition metal oxyfluorides, transition metal oxysulfides, and transition metal oxynitrides.

The positive electrode active material is not particularly limited as long as the material can reversibly progress the release and occlusion of lithium ions and the desorption and insertion of lithium ions. For example, positive electrode active materials used in known lithium-ion secondary batteries can be used.

Specifically, examples of the positive electrode active materials include lithium cobalt oxides (LiCoO₂), lithium nickel oxides (LiNiO₂), lithium manganese spinels (LiMn₂O₄), composite metal oxides represented by general formula: LiNiₓCo_{y}Mn_{z}MₐO₂ (x+y+z+a=1, 0≤x≤1, 0≤y≤1, 0≤z≤1, 0≤a≤1, M is one or more elements selected from Al, Mg, Nb, Ti, Cu, Zn, and Cr), lithium vanadium compounds (LiV₂O₅, Li₃V₂(PO₄)₃, LiVOPO₄), olivine type LiMPO₄ (here, M is one or more elements selected from Co, Ni, Mn, Fe, Mg, V, Nb, Ti, Al, and Zr), lithium titanates (Li₄Ti₅O₁₂), and composite metal oxides of LiNiₓCo_{y}Al_{z}O₂ (0.9<x+y+z<1.1).

Further, if a negative electrode active material doped with metallic lithium or lithium ions is placed on a negative electrode in advance, a positive electrode active material that does not contain lithium can also be used by starting the battery from discharging. Examples of such positive electrode active materials include lithium-free metal oxides (MnO₂, V₂O₅, etc.), lithium-free metal sulfides (MoS₂, etc.), lithium-free fluorides (FeF₃, VF₃, etc.), and the like.

### (Negative Electrode Active Material Layer)

The negative electrode active material layer 13 is on the side of the negative electrode current collector 15B in the solid electrolyte layer 12. The negative electrode active material layer 13 contains a negative electrode active material and may also contain a conductive additive, a binder, and a solid electrolyte to be described later if necessary.

The negative electrode active material contained in the negative electrode active material layer 13 may be any compound that can perform the occlusion and release of mobile ions, and the negative electrode active materials used in known lithium-ion secondary batteries can be used. Examples of the negative electrode active materials include alkali metals, alkali metal alloys, carbon materials such as graphite (natural graphite, artificial graphite), carbon nanotubes, non-graphitizable carbon, easily graphitizable carbon, and low-temperature calcined carbon, metals that can be combined with metals such as alkali metals such as aluminum, silicon, tin, germanium, and alloys thereof, oxides such as SiOₓ (0<x<2), iron oxide, titanium oxide, and tin dioxide, and lithium metal oxides such as lithium titanate (Li₄Ti₅O₁₂).

The conductive additive that may be contained in the positive electrode active material layer 11 and the negative electrode active material layer 13 is not particularly limited as long as the conductive additive improves the electronic conductivity of the positive electrode active material layer 11 and the negative electrode active material layer 13, and any known conductive additive can be used. Examples of the conductive additive include carbon-based materials such as graphite, carbon black, graphene, and carbon nanotubes, metals such as gold, platinum, silver, palladium, aluminum, copper, nickel, stainless steel, and iron, conductive oxides such as ITO, or mixtures thereof. The conductive additive may be in the form of powder or fiber.

### (Binder)

The binder joins the positive electrode current collector 15A and the positive electrode active material layer 11, joins the negative electrode current collector 15B and the negative electrode active material layer 13, joins the positive electrode active material layer 11, the negative electrode active material layer 13, and the solid electrolyte layer 12, joins various materials constituting the positive electrode active material layer 11, and joins various materials constituting the negative electrode active material layer 13.

For example, the binder is used inside a range that does not impair the functions of the positive electrode active material layer 11 and the negative electrode active material layer 13. The binder may be anything that allows the above-described joining, and examples thereof include fluororesins such as polyvinylidene fluoride (PVDF) and polytetrafluoroethylene (PTFE). Furthermore, in addition to the above, as a binder, for example, cellulose, styrene/butadiene rubber, ethylene/propylene rubber, polyimide resin, polyamideimide resin, and the like may be used. Furthermore, a conductive polymer having electronic conductivity or an ion conductive polymer having ionic conductivity may be used as the binder. Examples of conductive polymers with electronic conductivity include polyacetylene and the like. In this case, since the binder also performs the function of conductive additive particles, there is no need to add a conductive additive. As the ion conductive polymer with ionic conductivity, for example, one that conducts lithium ions etc. can be used and examples thereof include monomers of polymer compounds (polyether polymer compounds such as polyethylene oxide and polypropylene oxide, polyphosphazene, etc.), composites of lithium salts such as LiClO₄, LiBF₄, LiPF₆, LiTFSI, and LiFSI or alkali metal salts mainly composed of lithium, and the like. Examples of the polymerization initiator used for compounding include photopolymerization initiators or thermal polymerization initiators that are compatible with the above monomers. Characteristics required for binders include resistance to oxidation and reduction, and good adhesion. If the binder is unnecessary, it may not be included.

The amount of the binder in the positive electrode active material layer 11 is not particularly limited, but is preferably 0.5 to 30% by volume of the positive electrode active material layer from the viewpoint of lowering the resistance of the positive electrode active material layer 11. Further, the amount of the binder in the positive electrode active material layer 11 is preferably 0% by volume from the viewpoint of improving energy density.

The amount of the binder in the negative electrode active material layer 13 is not particularly limited, but is preferably 0.5 to 30% by volume of the negative electrode active material layer from the viewpoint of lowering the resistance of the negative electrode active material layer 13. Further, the amount of the binder in the negative electrode active material layer 13 is preferably 0% by volume from the viewpoint of improving energy density.

### (Solid Electrolyte Layer)

The solid electrolyte layer 12 is located between the positive electrode active material layer 11 and the negative electrode active material layer 13. The solid electrolyte layer 12 contains a solid electrolyte. The solid electrolyte is a substance (for example, particles) that can move ions by an externally applied electric field. Further, the solid electrolyte layer is an insulator that inhibits the movement of electrons.

The solid electrolyte contains, for example, lithium. The solid electrolyte may be, for example, a halide material having a composition represented by the following formula (1) or a sulfide material such as Li_{3.25}Ge_{0.25}P_{0.75}S₄.

$${A}_{a} {E}_{b} {G}_{c} {X}_{d} \qquad ( 1 )$$

(In Formula (1), A is at least one element selected from Li and Cs, E is at least one element selected from the group consisting of Al, Sc, Y, Zr, Hf, and lanthanoids, G is at least one element selected from the group consisting of OH, BO₂, BO₃, BO₄, B₃O₆, B₄O₇, CO₃, NO₃, AlO₂, SiO₃, SiO₄, Si₂O₇, Si₃O₉, Si₄O₁₁, Si₆O₁₈, PO₃, PO₄, P₂O₇, P₃O₁₀, SO₃, SO₄, SO₅, S₂O₃, S₂O₄, S₂O₅, S₂O₆, S₂O₇, S₂O₈, BF₄, PF₆, and BOB, X is at least one element selected from the group consisting of F, Cl, Br, and I, 0.5≤a<6, 0<b<2, 0≤c≤6, and 0<≤d≤6.1.)

The solid electrolyte may be, for example, a thiolisicone type compound or a glass compound. Li_{3.25}Ge_{0.25}P_{0.75}S₄ and Li₃PS₄ are examples of thiolysicone type compounds. Li₂S—P₂S₅ is an example of a glass compound. In addition to this, any material can be used as the solid electrolyte as long as the material can be used in the powder compaction method. The solid electrolyte may contain one or more of these compounds.

The solid electrolyte layer 12 may contain a material other than the solid electrolyte material. For example, the solid electrolyte layer 12 may contain an oxide or halide of an alkali metal element, an oxide or halide of a transition metal element, or the like. Further, the solid electrolyte layer 12 may also include a binder. The binder is the same as described above.

### (Insulating Sheet)

The insulating sheet 40 is disposed between the positive electrode current collector 15A and the negative electrode current collector 15B. The insulating sheet 40 spreads in the in-plane direction and surrounds the laminate 10 between the positive electrode current collector 15A and the negative electrode current collector 15B. The insulating sheet 40 is composed of at least one insulating film, and may be formed by laminating a plurality of insulating films into one piece. Further, the insulating sheet 40 may be a combination of a plurality of parts divided in the in-plane direction. When the insulating sheet 40 is formed by laminating a plurality of insulating films, for example, the ends perpendicular to the laminating direction are fixed with a tape or the like. In FIG. 2, the thickness of the insulating sheet 40 is indicated by T₄₀, and in FIGS. 2 and 3, the width of the insulating sheet 40 in the x direction is indicated by W40 and the length thereof in the y direction is indicated by L40.

The insulating sheet 40 is made of, for example, an insulating resin, and a known insulating material can be used. The insulating sheet 40 is preferably an insulating film that is easy to process. The insulating sheet 40 is made of, for example, polyethylene terephthalate, polypropylene, polyimide, or PTFE.

The insulating sheet 40 has, for example, the second through-hole H40 that penetrates in the z direction. The number of the second through-holes H40 of the insulating sheet 40 is at least one arbitrary number. The laminate 10 is accommodated inside the second through-hole H40.

The shape of the second through-hole H40 when viewed from above in the z direction is an arbitrary shape that allows the insulating sheet 40 to accommodate the laminate 10 therein. The second through-hole H40 may surround the laminate 10 when viewed from above in the z direction. The shape of the second through-hole H40 when viewed from above in the z direction is similar to, for example, the laminate 10. Hereinafter, a case in which the second through-hole H40 and the laminate 10 have a circular shape will be described.

The size of the second through-hole H40 when viewed from above in the z direction is larger than the size of the laminate 10. That is, an inner dimension d40 of the second through-hole H40 when viewed from above in the z direction is larger than an outer dimension D10 of the laminate 10. Therefore, the insulating sheet 40 and the laminate 10 are arranged to be separated from each other and a space R is formed between the insulating sheet 40 and the laminate 10. FIG. 3 shows a case in which the distance between the insulating sheet 40 and the laminate 10 is constant at any position, but the distance between the insulating sheet 40 and the laminate 10 may differ depending on the location. In FIG. 3, the inner dimension d40 indicates the diameter of the second through-hole H40. The outer dimension D10 indicates the diameter of the laminate.

The ratio d40/D10 of the inner dimension d40 of the second through-hole H40 with respect to the outer dimension D10 of the laminate 10 is preferably larger than 100%. The inner dimension d40 of the second through-hole H40 is preferably larger than the outer dimension D10 of the laminate 10 by 1 mm or more.

When the second through-hole H40 and the laminate have a similar shape, it is preferable that the clearance between the side of the second through-hole H40 and the side of the laminate which are in parallel be constant.

The shape of the second through-hole H40 and the laminate 10 when viewed from above in the z direction may have corners. The corners may be formed at right angles or curved. When the second through-hole H40 and the laminate 10 have corners, the clearance between the second through-hole H40 and the laminate 10 in the corners may not be constant.

### (Adhesive Sheet)

The adhesive sheet (adhesive layer) 50 surrounds, for example, the laminate 10. Specifically, the adhesive sheet 50 is provided with, for example, the first through-hole H50 for accommodating the laminate 10 therein. The adhesive sheet 50 may be a combination of a plurality of parts divided in the in-plane direction. The adhesive sheet 50 is disposed between the insulating sheet 40 and the positive electrode current collector 15A or between the insulating sheet 40 and the negative electrode current collector 15B. When there is a plurality of the adhesive sheets 50, the adhesive sheet 50 may be disposed between the insulating sheet 40 and the positive electrode current collector 15A and between the insulating sheet 40 and the negative electrode current collector 15B. The adhesive sheet 50 spreads in the in-plane direction. In FIGS. 2 and 3, the width of the adhesive sheet 50 in the x direction is indicated by W50 and the length thereof in the y direction is indicated by L50.

The adhesive sheet 50 overlaps the insulating sheet 40 in the z direction and joins the insulating sheet 40 and the positive electrode current collector 15A or the negative electrode current collector 15B. When there is a plurality of the adhesive sheets 50, each adhesive sheet 50 joins the insulating sheet 40 and the positive electrode current collector 15A and joins the insulating sheet 40 and the negative electrode current collector 15B. In this embodiment, the insulating sheet 40 and the adhesive sheet 50 that overlap in the z direction may be collectively referred to as a layered structure 45.

As the adhesive sheet 50, for example, a double-sided tape, an adhesive, or a thermal adhesive sheet is used.

A specific example of the double-sided tape is a double-sided tape in which an adhesive layer (adhesive part) is made of rubber, acrylic, or silicone material and a base material is nonwoven fabric, film, foam, cloth, or Japanese paper or a double-sided tape that does not require a base material and consists only of an adhesive layer (adhesive part).

Specific examples of adhesives used as the adhesive sheet 50 include vinyl resin, styrene resin, rubber, and ethylene resin adhesives.

As a specific example of the thermal adhesive sheet used as the adhesive sheet 50, an epoxy resin thermal adhesive sheet such as FB-ML80/FB-ML4 (manufactured by Nitto Denko Corporation) is used.

The adhesive sheet 50 may be in the form of a single sheet such as a tape. The adhesive sheet 50 may be formed into a sheet shape after curing, such as an adhesive.

In the all-solid-state battery 100 shown in FIGS. 1 to 3, the adhesive sheet 50 includes the first adhesive sheet 50A provided between the positive electrode current collector 15A and the insulating sheet 40 and the second adhesive sheet 50B provided between the negative electrode current collector 15B and the insulating sheet 40. The first adhesive sheet 50A bonds a main surface S40A of the insulating sheet 40 to a main surface S15A of the positive electrode current collector 15A. The second adhesive sheet 50B bonds a main surface S40B of the insulating sheet 40 to a main surface S15B of the negative electrode current collector 15B. The first adhesive sheet 50A and the second adhesive sheet 50B have substantially the same configuration, and in this embodiment, the configuration described as the characteristic of the adhesive sheet 50 is a characteristic common to the first adhesive sheet 50A and the second adhesive sheet 50B.

As described above, since the adhesive sheet 50 plays the role of adhering the current collector 15 and the insulating sheet 40, the arrangement and shape of the adhesive sheet 50 correspond to, for example, the arrangement and shape of the current collector 15. That is, the outer dimension of the adhesive sheet 50 is the same as, for example, the outer dimension of the current collector 15. By allowing the outer dimension of the adhesive sheet 50 to be the same as the outer dimension of the current collector 15, it is possible to maximize the adhering area between the insulating sheet 40 and the current collector 15.

A thickness T50 of the adhesive sheet 50 in the laminating direction is, for example, 1 to 150 μm. In the overlapping region of the adhesive sheet 50 and the insulating sheet 40, the total thickness of the adhesive sheet 50 and the insulating sheet 40 is indicated by a thickness T45. The ratio T45/T10 of the total thickness T45 of the adhesive sheet 50 and the insulating sheet 40 with respect to the thickness T10 of the laminate 10 is, for example, 20 to 100%, preferably 50 to 100%, and more preferably 65 to 95%.

The gap between the positive electrode current collector 15A and the negative electrode current collector 15B depends on, for example, the thickness of the structure sandwiched therebetween. For example, the region in which the laminate 10, the positive electrode current collector 15A, and the negative electrode current collector 15B overlap in the z direction is referred to as a first region and the region in which the adhesive sheet 50 and the insulating sheet 40 overlap in the z direction is referred to as a second region. In this case, a gap (hereinafter, referred to as a first gap) between the positive electrode current collector 15A and the negative electrode current collector 15B in the first region is wider than a gap (hereinafter, referred to as a second gap) between the positive electrode current collector 15A and the negative electrode current collector 15B in the second region. The ratio of the second gap with respect to the first gap is the same as the ratio T45/T10 of the total thickness T45 of the layered structure 45 in the second region with respect to the thickness T10 of the laminate 10.

Further, for example, when the total thickness T45 in the second region is smaller than the thickness T10 of the laminate 10, the second gap is smaller than the first gap. In such a configuration, for example, in the first region, the positive electrode current collector 15A and the negative electrode current collector 15B are recessed by the laminate 10. Thus, since the total thickness T45 of the adhesive sheet 50 and the insulating sheet 40 is inside the above-described range with respect to the thickness of the laminate 10, the laminate 10 can be easily brought into close contact with the current collector 15, the internal resistance can be easily reduced, and the chipping of the laminate can be easily suppressed.

The shape of the first through-hole H50 when viewed from above in the z direction is an arbitrary shape in which the adhesive sheet 50 can accommodate the laminate 10 therein. That is, an inner dimension d50 of the first through-hole H50 is equal to or larger than the outer dimension D10 of the laminate 10. The distance between the adhesive sheet 50 and the laminate 10 in the in-plane direction may differ for each position in the z direction. In this case, the shortest distance between the adhesive sheet 50 and the laminate 10 in the in-plane direction is referred to as the distance da. The distance da between the inner dimension d50 and the outer dimension D10 may be, for example, 0 mm or more and 1 mm or less, 0.1 mm or more and 1 mm or less, or 0.5 mm or more and 1 mm or less. The ratio D10/d50 between the outer dimension D10 of the laminate 10 and the inner dimension d50 of the first through-hole H50 may be, for example, 0.9 or more and 1 or less or 0.90 or more and 0.97 or less. In this way, it is easy to suppress the misalignment of the laminate 10 by correlating the inner dimension d50 of the adhesive sheet 50 with the outer dimension D10 of the laminate 10.

The first through-hole H50 has, for example, a circular shape when viewed from above. When viewed from above in the z direction, the first through-hole H50 and the second through-hole H40 preferably have a common center axis and have similar shapes, and are more preferably congruent. When the first through-hole H50 and the second through-hole H40 have a common center axis and are similar in shape, the shape of the first through-hole H50 is preferably larger than the shape of the second through-hole H40. Further, the inner dimension d50 of the first through-hole H50 is preferably equal to or larger than the inner dimension d40 of the second through-hole H40 and more preferably larger than the inner dimension d40 of the second through-hole H40. Furthermore, the shape of the first through-hole H50 matches the shape of the inner periphery around which the adhesive sheet 50 surrounds the laminate 10 and the shape of the second through-hole H40 matches the shape of the inner periphery around which the insulating sheet 40 surrounds the laminate 10. In FIG. 3, the inner dimension d50 indicates the diameter of the first through-hole H50.

Since the inner dimension d50 of the first through-hole H50 is equal to or larger than the inner dimension d40 of the second through-hole H40, the inner end of the main surface S40 (the main surface S40A or the main surface S40B) of the insulating sheet 40 in the radial direction can be bonded to the main surface S15 (the main surface S15A or the main surface S15B) of the current collector 15. Therefore, it is easier to obtain the effect of suppressing fragments of the laminate 10 from entering between the insulating sheet 40 and the current collector 15. Thus, it is easy to obtain the effect of suppressing deterioration in aesthetics and an increase in internal resistance of the all-solid-state battery 100 with this configuration. FIGS. 2 and 3 show an example in which the shape of the first through-hole H50 of the adhesive sheet 50 is congruent with the shape of the second through-hole H40 of the insulating sheet 40. Since it is possible to use the adhesive sheet 50 in use without waste by allowing the shape of the first through-hole H50 to be congruent with the shape of the second through-hole H40, it is possible to suppress manufacturing costs and to easily obtain the effect of adhering the current collector 15 and the insulating sheet 40.

The first through-hole H50 and the second through-hole H40 may not have a similar shape when viewed from above in the z direction. The shape of the first through-hole H50 may be an arbitrary shape which surrounds the second through-hole H40 when viewed from above in the z direction. Accordingly, it is possible to reduce the number of the adhesive sheets 50 to be used and reduce manufacturing costs while suppressing misalignment and cracking of the laminate.

The laminate 10 may be directly joined to the current collector 15. In this embodiment, since the adhesive sheet 50 has the first through-hole H50 that surrounds the laminate 10 when viewed from above in the z direction, the laminate 10 can be directly joined to the current collector 15. Accordingly, it is easy to reduce the internal resistance of the all-solid-state battery 100.

The adhesive sheet 50 may be formed in a portion in which the current collector 15 and the insulating sheet 40 overlap each other when viewed from above in the z direction. Accordingly, it is possible to suppress misalignment and cracking of the laminate. Further, even when the adhesive sheet 50 is formed of, for example, an insulating sheet, it is possible to ensure the conductivity between the laminate 10 and the current collector 15.

<Method of Manufacturing all-Solid-State Battery>

Next, an example of a method of manufacturing the all-solid-state battery according to this embodiment will be described. The all-solid-state battery according to this embodiment is manufactured by the powder compaction method.

### (Step of Forming Laminate)

First, a resin holder having a through-hole at the center, a lower punch, and an upper punch are prepared. A metal holder made of die steel may be used instead of the resin holder to improve moldability. The diameter of the through-hole of the resin holder can be set to a desired size as the outer dimension D10 of the laminate 10. The diameter of the through-hole of the resin holder is set to, for example, 10 mm and the diameters of the lower punch and the upper punch are set to, for example, 9.99 mm. The lower punch is inserted from below the through-hole of the resin holder and powdered solid electrolyte is input from the opening side of the resin holder. Subsequently, the upper punch is inserted onto the input powdered solid electrolyte and is placed on a pressing machine for pressing. The pressing pressure is set to, for example, 5 kN (1.7 MPa). The powdered solid electrolyte is pressed by the upper punch and the lower punch inside the resin holder to be the solid electrolyte layer 12.

Subsequently, the upper punch is once removed and the material for the positive electrode active material layer is input to the upper punch side in the solid electrolyte layer 12. Then, the upper punch is inserted and pressed again. The pressing pressure is set to, for example, 5 kN (1.7 MPa). The material for the positive electrode active material layer becomes the positive electrode active material layer 11 by pressing.

Subsequently, the lower punch is temporarily removed and the material for the negative electrode active material layer is input to the lower punch side in the solid electrolyte layer 12. For example, the material for the negative electrode active material layer is input onto the solid electrolyte layer 12 so that the sample is turned upside down and faces the positive electrode active material layer 11. Then, the lower punch is inserted and pressed again. The pressing pressure is set to, for example, 5 kN (1.7 MPa). After that, a pressure of 20 kN (7 MPa) is applied for main molding. The material for the negative electrode active material layer becomes the negative electrode active material layer 13 by reapplying strong pressure after temporary molding.

Subsequently, the laminate 10 in which the positive electrode active material layer 11, the solid electrolyte layer 12, and the negative electrode active material layer 13 are laminated in this order is extracted from the resin holder. In order to extract the laminate 10 from the resin holder, the upper punch is inserted and pressed, for example, while the lower punch is removed. Further, the lower punch is inserted and pressed while the upper punch is removed. In this way, the laminate 10 is obtained.

### (Step of Forming Insulating Sheet and Adhesive Sheet)

The insulating sheet 40 and the adhesive sheet 50 are obtained, for example, by applying a double-sided tape to an insulating film having a predetermined outer shape and forming the second through-holes H40 and H50.

That is, an insulating film having a predetermined outer shape is first prepared.

Subsequently, an adhesive sheet material that spreads in the in-plane direction is provided on the main surface of the insulating film. As the adhesive sheet material, for example, a double-sided tape is used.

Subsequently, the insulating film with the double-sided tape on the main surface is pressed with the mold and cut. The shape of the mold is the shape of the desired second through-holes H40 and H50. The mold is installed at a desired position for forming the second through-holes H40 and H50 in the insulating film. For example, a punching blade is used to cut the insulating film. As the punching blade, a Pinnacle blade (Pinnacle is a registered trademark) or the like can be used. In this way, it is possible to obtain the layered structure 45 in which the first adhesive sheet 50A and the second adhesive sheet 50B are respectively provided on the main surfaces S40A and S40B of the insulating sheet 40.

### (Step of Forming Positive Electrode Current Collector and Negative Electrode Current Collector)

The positive electrode current collector 15A and the negative electrode current collector 15B are obtained by punching a current collector material into a desired shape using, for example, a punching blade. As the punching blade, for example, a Pinnacle blade (Pinnacle is a registered trademark) can be used.

### (Assembly)

First, leads 16 and 14 which are tab leads are respectively attached to the outside of the positive electrode current collector 15A and the negative electrode current collector 15B in the laminating direction. The joining between the lead 16 and the positive electrode current collector 15A and the joining between the lead 14 and the negative electrode current collector 15B can be performed by, for example, ultrasonic welding.

Subsequently, the insulating sheet 40 is bonded to at least one of the positive electrode current collector 15A and the negative electrode current collector 15B via the adhesive sheet 50. Hereinafter, an example in which the insulating sheet 40 is bonded to the positive electrode current collector 15A via the first adhesive sheet 50A will be described, but the insulating sheet 40 may be bonded to the negative electrode current collector 15B via the second adhesive sheet 50B.

Subsequently, the laminate is accommodated inside the second through-holes H40 and H50 of the layered structure 45 using tweezers or the like.

Subsequently, the insulating sheet 40 is bonded to the negative electrode current collector 15B via the second adhesive sheet 50B so that the laminate 10 and the layered structure 45 are sandwiched between the positive electrode current collector 15A and the negative electrode current collector 15B.

Subsequently, the exterior body 20 heat-sealed except for one opening portion. Then, the remaining opening portion may be heat-sealed while the inside of the exterior body 20 is evacuated. Since the heat-sealing is performed in an evacuated state, the exterior body 20 can be sealed in a state where gas and moisture present in the accommodation space K are small.

Subsequently, the exterior body 20 is sandwiched between metal plates via baking plates and four corners of the metal plates are fastened with bolts and nuts to restrain them. Here, as the metal plate, a metal plate whose size in the x direction or the y direction is larger than the exterior body 20 can be used.

With the above-described steps, the all-solid-state battery 100 of this embodiment is obtained. In the method of manufacturing the all-solid-state battery according to this embodiment, the layered structure 45 including the insulating sheet 40 and the adhesive sheet 50 having the second through-holes H40 and H50 is obtained just by providing the adhesive sheet material spreading in the in-plane direction on the insulating sheet 40 and pressing the adhesive sheet material by the mold. Therefore, in the method of manufacturing the all-solid-state battery according to this embodiment, it is possible to easily adjust the shape and number of the second through-holes H40 and H50 just by changing the number and shape of the mold. Thus, in the method of manufacturing the all-solid-state battery according to this embodiment, it is possible to simply manufacture the all-solid-state battery 100. Further, in the method of manufacturing the all-solid-state battery according to this embodiment, since it is easy to form the insulating sheet 40 in a desired structure, it is easy to respond to higher capacity batteries such as multi-layering and larger area.

Furthermore, an example has been described in which the all-solid-state battery 100 is manufactured by using a double-sided tape as an adhesive sheet material, but the present invention is not limited to this example. For example, the method of manufacturing the all-solid-state battery according to this embodiment may use an adhesive or a thermal adhesive sheet instead of the double-sided tape as the adhesive sheet material. When the adhesive is used as the adhesive sheet material, for example, the adhesive may be provided to overlap the main surfaces S40A and S40B of the insulating sheet 40 immediately before the insulating sheet 40 is bonded to the current collector 15. When the thermal adhesive sheet is used as the adhesive sheet material, for example, the insulating sheet 40 and the adhesive sheet 50 accommodating the laminate 10 inside the second through-holes H40 and H50 may be heated while being sandwiched between the positive electrode current collector 15A and the negative electrode current collector 15B. In this way, it is possible to form the power storage element 90 in which the main surface S15 of the current collector 15 and the main surface S40 of the insulating sheet 40 are bonded via the adhesive sheet 50. Further, an example has been described in which the adhesive sheet material is provided on the insulating sheet 40 and punched out, but the present invention is not limited to this example. For example, the adhesive sheet 50 and the insulating sheet 40 may be separately punched and then laminated.

Further, an example has been described in which the leads 14 and 16 are attached to the outside of the positive electrode current collector 15A and the negative electrode current collector 15B in the laminating direction, but the present invention is not limited to this example. For example, the leads 14 and 16 may be attached to the inside of the positive electrode current collector 15A and the negative electrode current collector 15B in the laminating direction.

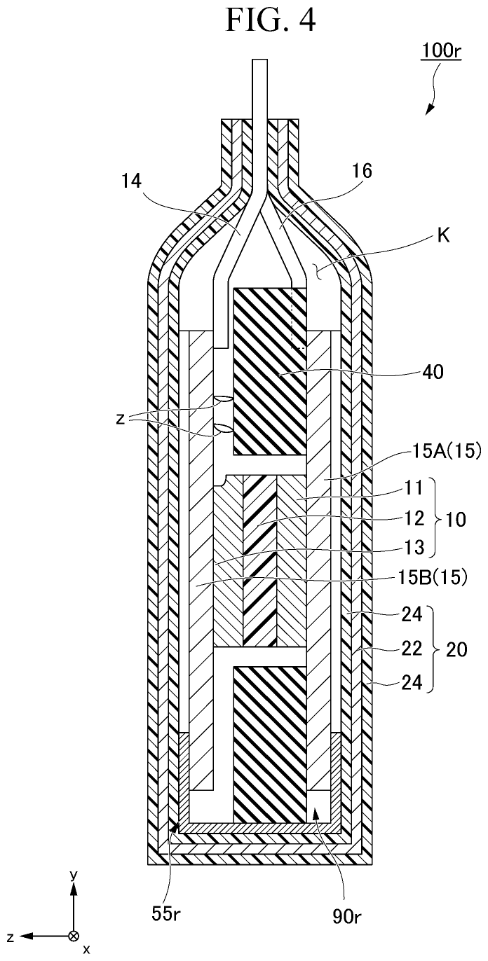

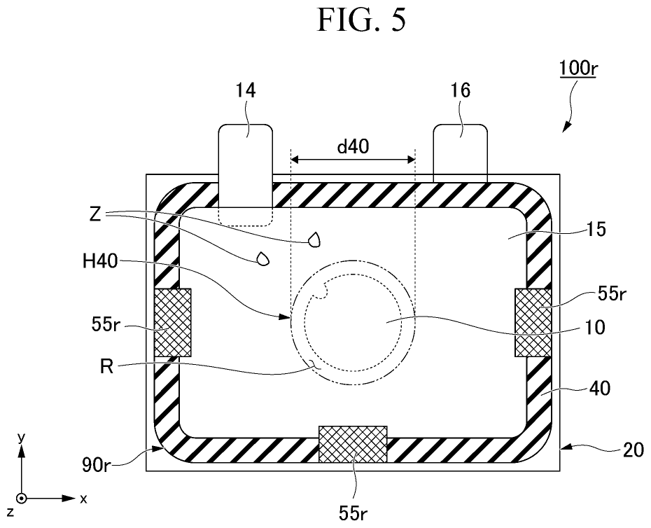

Hereinafter, the action and effect of the all-solid-state battery 100 according to this embodiment will be described with reference to Comparative Examples. FIG. 4 is a cross-sectional view of an all-solid-state battery 100r according to Comparative Example and FIG. 5 is a plan view of the all-solid-state battery 100r.

The all-solid-state battery 100r is different from the all-solid-state battery 100 in that the adhesive sheet 50 is not provided and the insulating sheet 40 is fixed differently. As shown in FIG. 4, the all-solid-state battery 100r fixes the surfaces far from the laminate 10 in the main surface of the current collector 15 by a fixed tape 55r and indirectly fixes the insulating sheet 40. Since the all-solid-state battery 100r does not have the adhesive sheet 50, the insulating sheet 40 cannot be fixed to the current collector 15 and a gap may be formed between the insulating sheet 40 and the current collector 15.

In the all-solid-state battery 100r, since the insulating sheet 40 is provided, it is possible to suppress the occurrence of short circuits due to the misalignment and cracking of the laminate 10 in the in-plane direction and the contact between the positive electrode current collector 15A and the negative electrode current collector 15B. However, for example, the insulating sheet 40 and the laminate 10 may be displaced from each other and the end of the laminate 10 may be chipped due to, for example, a collision. In the all-solid-state battery 100r, powder Z obtained by chipping the laminate 10 may enter between the insulating sheet 40 and the current collector 15 from the inside in the radial direction.

A power storage element 90r of the all-solid-state battery 100r is restrained by sandwiching the exterior body 20 between metal plates via baking plates, and fastening four corners of the metal plates with bolts and nuts. In the power storage element 90r, when the powder Z is located between the insulating sheet 40 and the current collector 15, the powder Z is in close contact with the current collector 15 and the exterior body 20 and the aesthetics of the all-solid-state battery 100r deteriorates. Further, the powder Z reduces the adhesion between the current collector 15 and the laminate 10 and the internal resistance increases. Further, when the laminate 10 is fastened while the powder Z enters between the current collector 15 and the insulating sheet 40 or between the laminate 10 and the current collector 15, excessive stress may be applied to the laminate 10 to cause cracking.

Further, in the above-described example, a case is shown in which the powder Z enters between the insulating sheet 40 and the current collector 15, but the powder Z may enter between the laminate 10 and the current collector 15. Even in such a case, the aesthetics of the all-solid-state battery 100r deteriorates and the internal resistance increases.

In contrast, in the all-solid-state battery 100 of this embodiment, the insulating sheet 40 is bonded to the current collector 15 via the adhesive sheet 50. Therefore, the position of the insulating sheet 40 in the power storage element 90 is fixed, the insulating sheet 40 and the laminate 10 are less like to collide, and powder is less likely to be generated due to chipping of the laminate 10. Further, even when powder is generated, the insulating sheet 40 and the current collector 15 are bonded together and no gap is formed therebetween. Accordingly, it is possible to suppress the powder from entering between the insulating sheet 40 and the current collector 15. Thus, in the all-solid-state battery 100 according to this embodiment, it is possible to suppress deterioration in aesthetics and to further suppress a decrease in internal resistance due to the close contact between the laminate 10 and the current collector 15.

Further, the all-solid-state battery 100 according to this embodiment can form the second through-hole H40 in the insulating sheet 40 and form the first through-hole H50 in the adhesive sheet 50. Thus, it is possible to form the insulating sheet 40 and the adhesive sheet 50 having the second through-holes H40 and H50 provided therein by a simple process and to simply manufacture the all-solid-state battery 100.

Up to this point, a specific example of the all-solid-state battery 100 according to the first embodiment has been described in detail. The present invention is not limited to this example and various modifications and changes can be made in the scope of the gist of the present invention described in claims. Hereinafter, an all-solid-state battery according to a modified example will be described. In the all-solid-state battery according to the modified example, components similar to those of the all-solid-state battery 100 will be denoted by the same reference numerals, and description thereof will be omitted.

### Modified Example 1

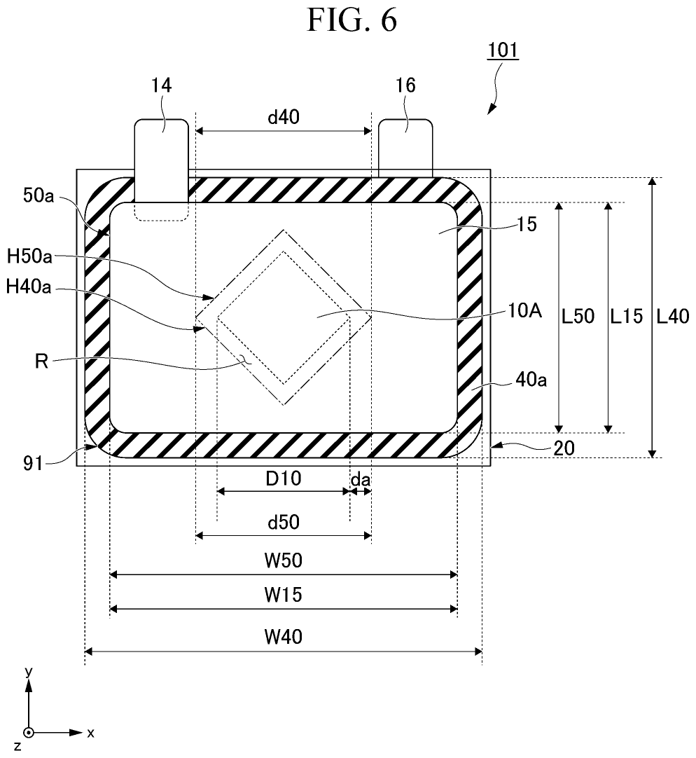

FIG. 6 is a plan view of an all-solid-state battery 101 according to Modified Example 1. The all-solid-state battery 101 is different from the all-solid-state battery 100 in that a laminate 10A and a first through-hole H50a of an adhesive sheet 50a and a second through-hole H40a of an insulating sheet 40a of a power storage element 91 do not have a circular shape.

The shapes of the laminate 10A, the first through-hole H50a of the adhesive sheet 50a, and the second through-hole H40a of the insulating sheet 40a are, for example, square. In addition, the shapes of the laminate 10A, the first through-hole H50a of the adhesive sheet 50a, and the second through-hole H40a of the insulating sheet 40a can be arbitrarily selected such as triangular, elliptical, star-shaped, and the like. The shapes of the laminate 10A, the first through-hole H50a of the adhesive sheet 50a, and the second through-hole H40a of the insulating sheet 40a are preferably similar or congruent, but do not necessarily have to be similar or congruent, and may be arbitrarily selected in combination.

The shapes of the laminate 10A, the first through-hole H50a of the adhesive sheet 50a, and the second through-hole H40a of the insulating sheet 40a can be selected depending on the shape of the punching blade. Even in the all-solid-state battery 101, it is possible to obtain the same effect as the all-solid-state battery 100.

### Modified Example 2

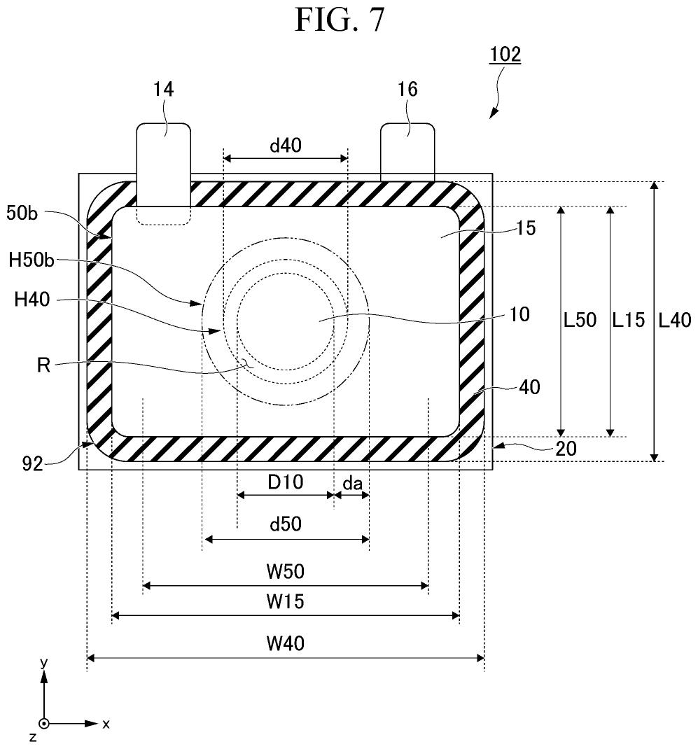

FIG. 7 is a plan view of an all-solid-state battery 102 according to Modified Example 2. The all-solid-state battery 102 is different from the all-solid-state battery 100 in that the inner dimension d50 of a first through-hole H50b of an adhesive sheet 50b provided in a power storage element 92 is larger than the inner dimension of the second through-hole H40 of the insulating sheet 40.

The ratio d50/d40 of the inner dimension d50 of the first through-hole H50 with respect to the inner dimension d40 of the second through-hole H40 is, for example, 140% or less and preferably 120% or less. The ratio d50/d40 is preferably 100% or more and more preferably larger than 100%.

The all-solid-state battery 102 is formed, for example, by separating the step of forming the first through-hole H50b in the adhesive sheet 50b and the step of forming the second through-hole H40 in the insulating sheet 40.

Even in the all-solid-state battery 102, since the adhesive sheet 50b, the insulating sheet 40, and the current collector 15 are in close contact with each other, it is possible to prevent the collision between the insulating sheet 40 and the laminate 10 and to suppress the misalignment and cracking of the laminate 10. Further, since the insulating sheet 40 and the current collector 15 are in close contact with each other via the adhesive sheet 50b even when the powder Z is generated, the gap between the insulating sheet 40 and the current collector 15 is small and the entrance of the powder Z can be suppressed even in a region not provided with the adhesive sheet 50b. That is, it is possible to suppress deterioration in aesthetics or an increase in internal resistance.

Since the ratio d50/d40 is inside the above-described range, the laminate 10 can be more reliably inserted into the second through-hole H40 and the first through-hole H50. When the ratio d50/d40 is outside the above-described range, the laminate is less likely to be inserted into the through-hole or the adhesion between the current collector 15 and the insulating sheet 50 may deteriorate.

### Modified Example 3

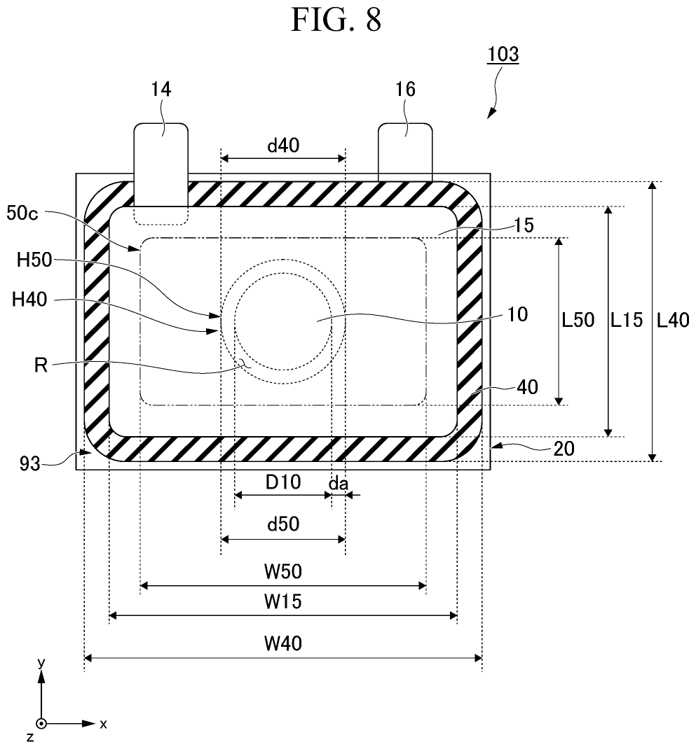

FIG. 8 is a plan view of an all-solid-state battery 103 according to Modified Example 3. The all-solid-state battery 103 is different from the all-solid-state battery 100 in that the outer dimension of the adhesive sheet 50c provided in a power storage element 93 is smaller than the outer dimension of the current collector 15.

The ratio of the outer dimension of the adhesive sheet 50c with respect to the outer dimension of the current collector 15 is, for example, 15 to 100% and preferably 60 to 100%. When the outer dimension of the adhesive sheet 50c is inside the above-described range, the adhesion between the insulating sheet 40 and the current collector 15 can be ensured.

Even in the all-solid-state battery 103, since the close contact between the insulating sheet 40 and the current collector 15 on the inside in the radial direction is ensured, it is possible to obtain the same effect as the all-solid-state battery 100.

### Modified Example 4

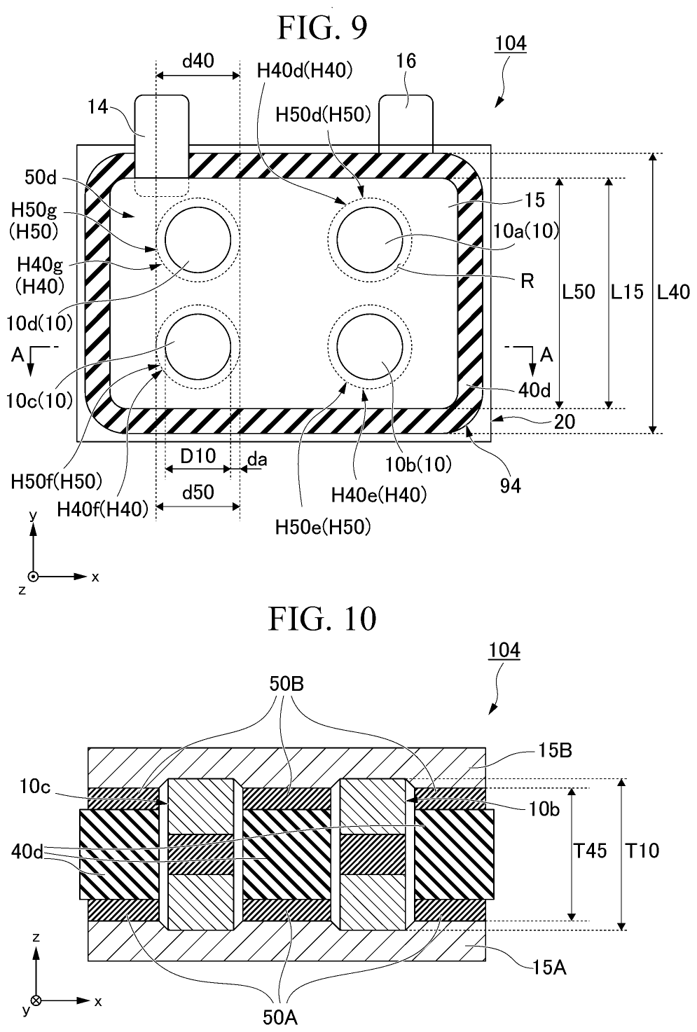

FIG. 9 is a plan view of an all-solid-state battery 104 according to Modified Example 4. FIG. 10 is a cross-sectional view taken along a cut line A-A of the power storage element 94 in FIG. 9. The all-solid-state battery 104 is different from the all-solid-state battery 100 in that the plurality of laminates 10 and the second through-holes H40 and H50 are provided in the insulating sheet 40d and the adhesive sheet 50d of the power storage element 94. The all-solid-state battery 104 includes, for example, four laminates 10a, 10b, 10c, and 10d. With this configuration, the adhesive sheet 50d includes first through-holes H50d, H50e, H50f, and H50g which respectively accommodating the laminates 10a, 10b, 10c, and 10d therein and the insulating sheet 40 includes second through-holes H40d, H40e, H40f, and H40g which respectively accommodate the laminates 10a, 10b, 10c, and 10d therein.

The all-solid-state battery 104 can be obtained by the same manufacturing method as that of the all-solid-state battery 100. Even in the all-solid-state battery 104, it is possible to obtain the same effect as the all-solid-state battery 100.

### Modified Example 5

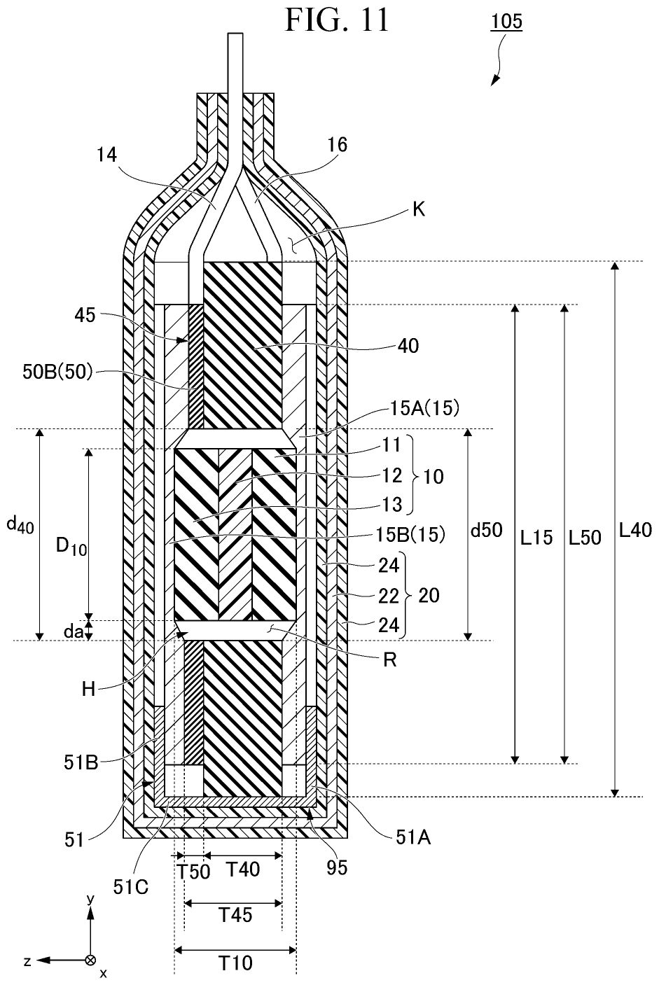

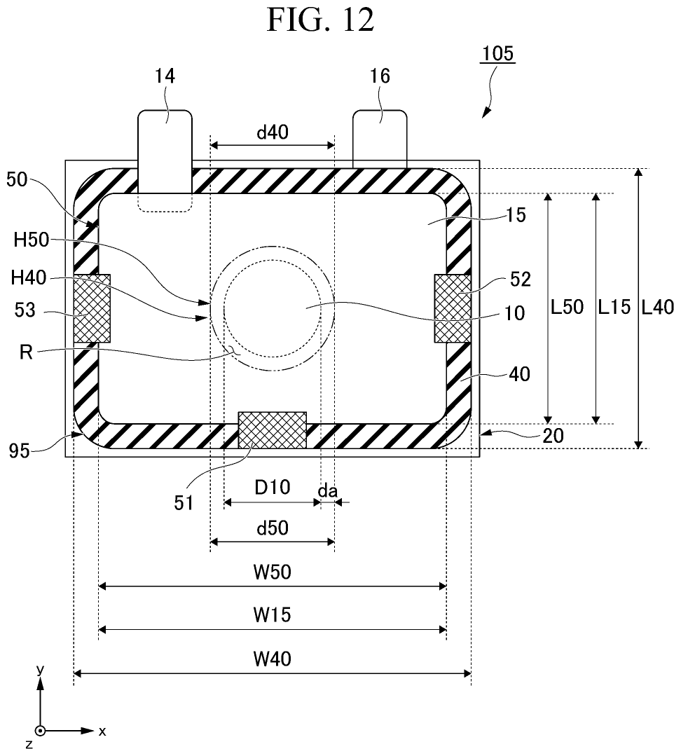

FIG. 11 is a cross-sectional view of an all-solid-state battery 105 according to Modified Example 5. FIG. 12 is a plan view of the all-solid-state battery 105. The all-solid-state battery 105 is different from the all-solid-state battery 100 in that the power storage element 95 includes only the second adhesive sheet 50B and includes fixed tapes (adhesive tapes) 51, 52, and 53.

The all-solid-state battery 105 includes the second adhesive sheet 50A between the insulating sheet 40 and the negative electrode current collector 15A, but does not include the adhesive sheet between the insulating sheet 40 and the positive electrode current collector 15A.

The second adhesive sheet 50B bonds the insulating sheet 40 and the negative electrode current collector 15B. In the overlapping region in which the second adhesive sheet 50B and the insulating sheet 40 overlap each other, the total thickness T45 of the thickness T50 of the second adhesive sheet 50B and the thickness T40 of the insulating sheet 40 is equal to or smaller than, for example, the thickness T10 of the laminate 10. The ratio T45/T10 of the total thickness T45 with respect to the thickness T10 of the laminate 10 is, for example, 20% to 100%, preferably 50% to 100%, and more preferably 65% to 90%. When the ratio T45/T10 of the total thickness T45 with respect to the thickness T10 is inside the above-described range, the laminate 10 can be easily brought into close contact with the current collector 15.

The all-solid-state battery 105 includes, for example, at least one of the fixed tapes 51, 52, and 53 which fix the surfaces opposite to the laminate 10 in the main surfaces of two current collectors 15A and 15B and the side surface of the insulating sheet 40. The fixed tapes 51, 52, and 53 are respectively located, for example, on different sides of the current collector 15. Each of the fixed tapes 51, 52, and 53 includes, for example, a first portion which contacts the surface on the side opposite to the surface contacting the laminate 10 in the positive electrode current collector 15A, a second portion which contacts the surface on the side opposite to the surface contacting the laminate 10 in the negative electrode current collector 15B, and a third portion which spreads in the z direction and connects together the first portion and the second portion. FIG. 11 shows a first portion 51A, a second portion 51B, and a third portion 51C of the fixed tape 51.

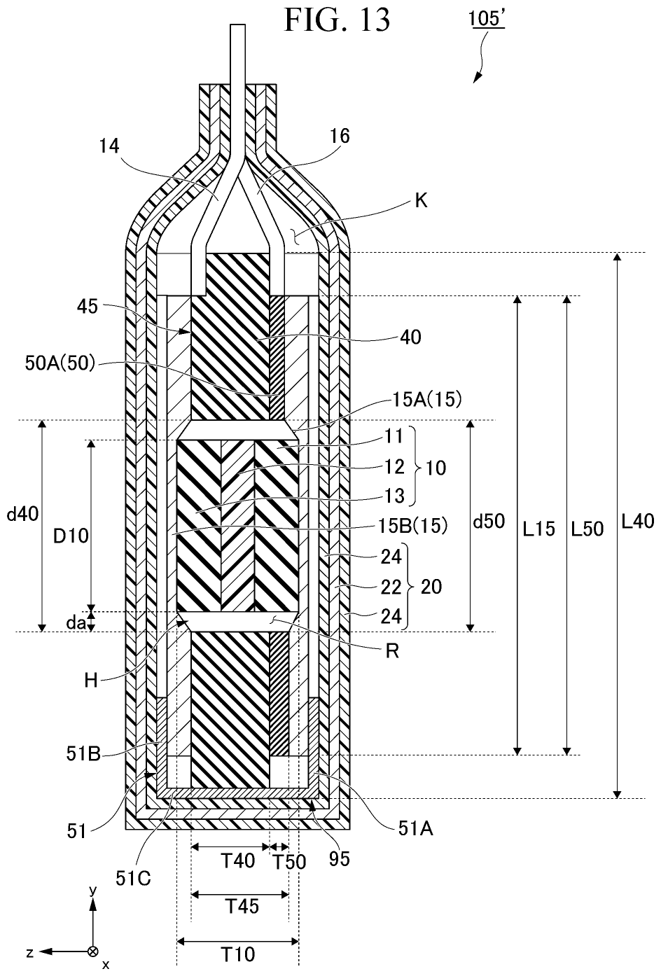

In the above-described embodiment, an example is shown in which the second adhesive sheet 50B serving as the adhesive sheet 50 is provided between the negative electrode current collector 15B and the insulating sheet 40, but this embodiment is not limited to this example. Specifically, as in FIG. 13, an all-solid-state battery 105′ having the first adhesive sheet 50A between the positive electrode current collector 15A and the insulating sheet 40 may be provided. When the direction in which the all-solid-state battery 105 is used is determined, the upper current collector 15 is preferably bonded to the insulating sheet 40.

Even in the all-solid-state batteries 105 and 105′, it is possible to obtain the same effect as the all-solid-state battery 100. Furthermore, in the above-described embodiment, an example is shown in which three fixed tapes, that is, the fixed tapes 51, 52, and 53 are provided, but the fixed tapes 51, 52, and 53 may not be provided. Here, one fixed tape may be provided and two or more (any number of) fixed tapes may be provided. As the number of the fixed tapes increases, stress applied to the insulating sheet 40 in the laminating direction increases, the position of the insulating sheet 40 is easily fixed, and the above-described effect can be easily obtained. On the other hand, since the insulating sheet 40 can be fixed by the adhesive sheet 50 even when the fixed tapes 51, 52, and 53 are not provided, the above-described effect can be obtained.

### Modified Example 6

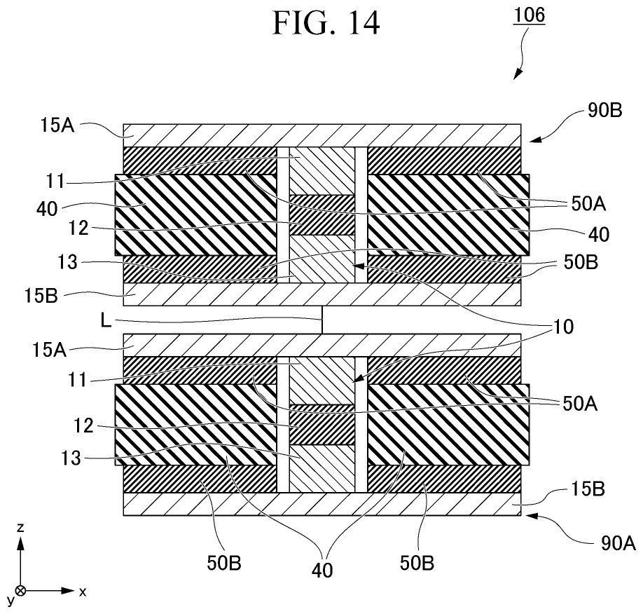

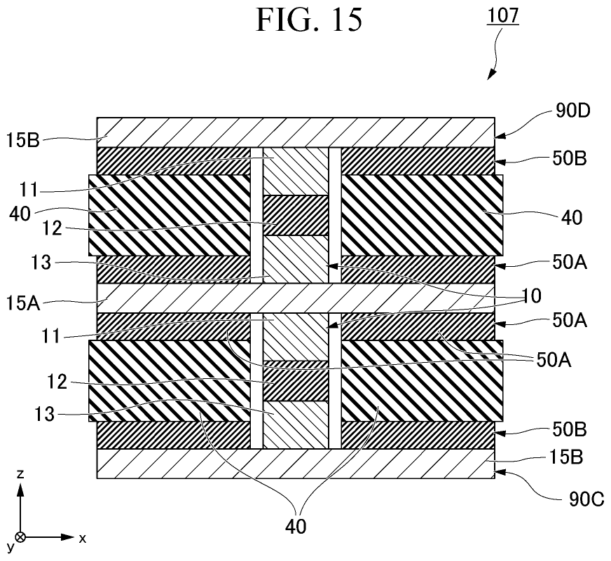

Modified Example 6 is different from the all-solid-state battery 100 in that a plurality of power storage elements are provided in a laminating direction. FIGS. 14 and 15 are schematic cross-sectional views of all-solid-state batteries 106 and 107 according to Modified Example 6. In FIGS. 14 and 15, for convenience of explanation, the exterior body 20 is omitted. The arrangement of the all-solid-state batteries 106 and 107 according to Modified Example 6 when viewed from above in the laminating direction is similar to the arrangement of the all-solid-state battery 100 according to the first embodiment. This is an example in which the all-solid-state batteries 106 and 107 are electrically connected in series and in parallel. FIG. 14 shows an example in which the thickness of the laminate 10 is the same as the thickness of the layered structure 45.

In the all-solid-state battery 106, the plurality of power storage elements 90A and 90B overlapping in the laminating direction are electrically connected in series via, for example, a conductor L. The conductor L connects, for example, the positive electrode current collector 15A of the power storage element 90A and the negative electrode current collector 15B of the power storage element 90B. In the all-solid-state battery 106, the lead 16 is connected to the positive electrode current collector 15A of the power storage element 90B. The lead 14 is connected to the negative electrode current collector 15B of the power storage element 90B. The configurations of the power storage elements 90A and 90B other than the leads 14 and 16 are similar to those of the power storage element 90.

In the all-solid-state battery 107, power storage elements 90C and 90D are arranged to be inverted from each other so that the polarities of the current collectors at both ends in the z direction are the same. That is, the polarity of the current collector on the inside in the z direction is different from the polarities of the current collector at both ends in the z direction. The current collector on the inside in the z direction may be shared by the power storage elements 90C and 90D or may be independently prepared in the power storage elements 90C and 90D and electrically connected to each other via the conductor. In the all-solid-state battery 107 shown in FIG. 15, the lead 16 is connected to the positive electrode current collector 15A located on the inside in the z direction. A plurality of the leads 14 are prepared and connected to the respective current collectors located at both ends in the z direction. That is, in FIG. 15, the lead 16 is connected to the positive electrode current collector 15A and two leads 14 are connected to the negative electrode current collector 15B.

Even in the all-solid-state battery 106 according to Modified Example 6, it is possible to obtain the same effect as the all-solid-state battery 100. Further, since the all-solid-state battery 106 has twice the number of the power storage elements electrically connected in series compared to the all-solid-state battery 100, it has been confirmed that the voltage output can be approximately doubled by experiments. Further, since the all-solid-state battery 107 has twice the number of the power storage elements electrically connected in parallel compared to the all-solid-state battery 100, it has been confirmed that the battery capacity is approximately doubled and the resistance is approximately halved by experiments. Furthermore, the inverted power storage element may be reversed to the example shown in FIG. 15.

### Modified Example 7

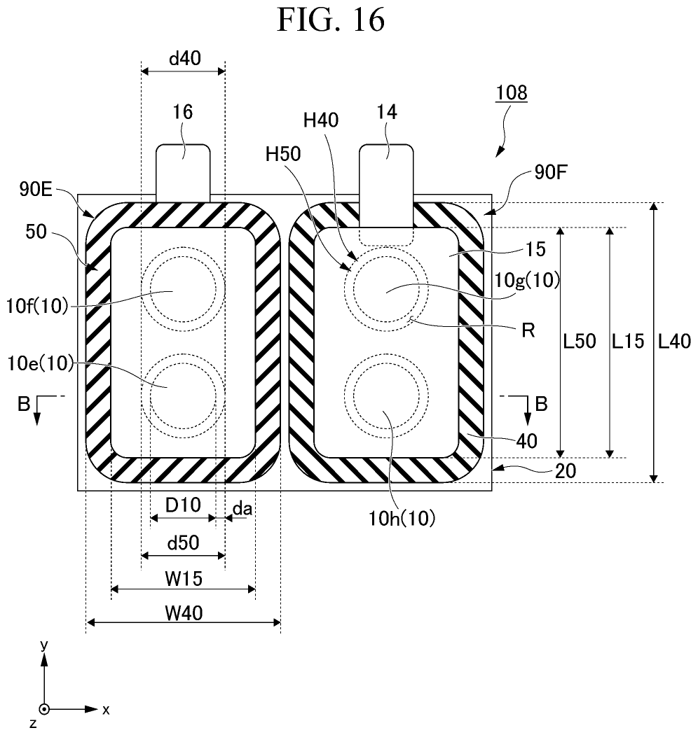

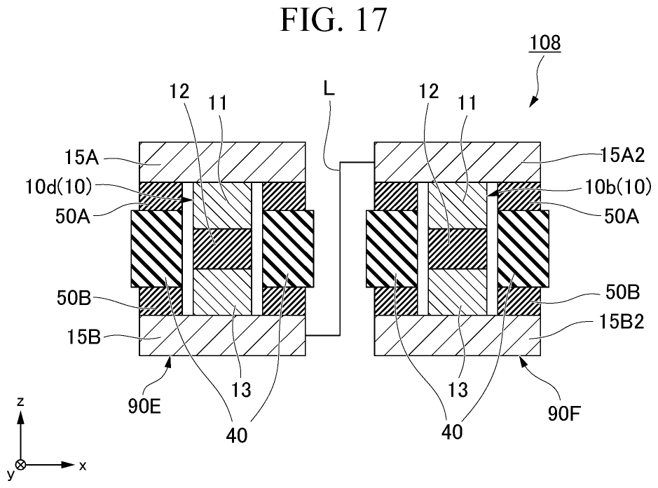

FIG. 16 is a schematic plan view of an all-solid-state battery 108 according to Modified Example 7. FIG. 17 is a schematic cross-sectional view of the all-solid-state battery 105 according to Modified Example 7. For convenience of explanation, the exterior body 20 in FIG. 16 is simplified and the exterior body 20 in FIG. 17 is omitted. The all-solid-state battery 108 according to Modified Example 7 includes a plurality of power storage elements 90E and 90F. In the all-solid-state battery 108, the plurality of power storage elements 90E and 90F are arranged side by side inside, for example, the same exterior body 20. The configurations of the power storage elements 90E and 90F are different from the power storage element 90 only in the number of the laminates 10, the second through-holes H40, and the first through-holes H50.

In the all-solid-state battery 108, the power storage elements 90E and 90F are connected by, for example, the conductor L. In the all-solid-state battery 108, the power storage elements 90E and 90F are electrically connected in series, but may be connected in parallel. In the all-solid-state battery 108, the lead 16 is connected to the positive electrode current collector 15A of the power storage element 90E and the lead 14 is connected to the negative electrode current collector 15B of the power storage element 90F.

Even in the all-solid-state battery 108 according to Modified Example 7, it is possible to obtain the same effect as the all-solid-state battery 100 according to the first embodiment. Further, in the all-solid-state battery 108 shown in FIGS. 16 and 17, since two power storage elements 90E and 90F are electrically connected in series, the voltage output is approximately doubled. Further, in the all-solid-state battery 108, since two power storage elements 90E and 90F are arranged in one all-solid-state battery, the battery capacity is approximately doubled.

### Modified Example 8

FIG. 18 is a schematic plan view of an all-solid-state battery 109 according to Modified Example 8. The all-solid-state battery 109 according to Modified Example 8 is different from the all-solid-state battery 100 in that a plurality of power storage elements 90 and 90 are provided inside the same plane. In FIG. 18, for convenience of explanation, the exterior body 20 is simplified.

In the all-solid-state battery 109 according to Modified Example 8, the plurality of power storage elements 90 and 90 are accommodated inside, for example, the same exterior body 20. The power storage elements 90 and 90 are connected by, for example, a conductor L. In this way, the plurality of power storage elements 90 and 90 are electrically connected in series. In the all-solid-state battery 109, an insulating seal 60 may be provided between the adjacent power storage elements 90 and 90.

Even in the all-solid-state battery 109 according to Modified Example 8, it is possible to obtain the same effect as the all-solid-state battery 100 according to the first embodiment. Further, in the all-solid-state battery 109, since the plurality of power storage elements 90 and 90 are electrically connected in series, the voltage output increases compared to the all-solid-state battery 100 according to the first embodiment. An increase in voltage output depends on the number of the laminates 10. In the configuration in which two power storage elements 90 are provided as shown in FIG. 18, the voltage output is doubled. Furthermore, in the drawings, an example is shown in which the insulating seal 60 is provided and the lead 16 and the lead 14 are connected by the conductor L outside the exterior body 20. This embodiment is not limited to this example and a series structure may be provided in which the positive electrode current collector 15A and the negative electrode current collector 15B of the adjacent power storage elements 90 and 90 inside the exterior body 20 are connected without using the insulating seal 60.

### Modified Example 9

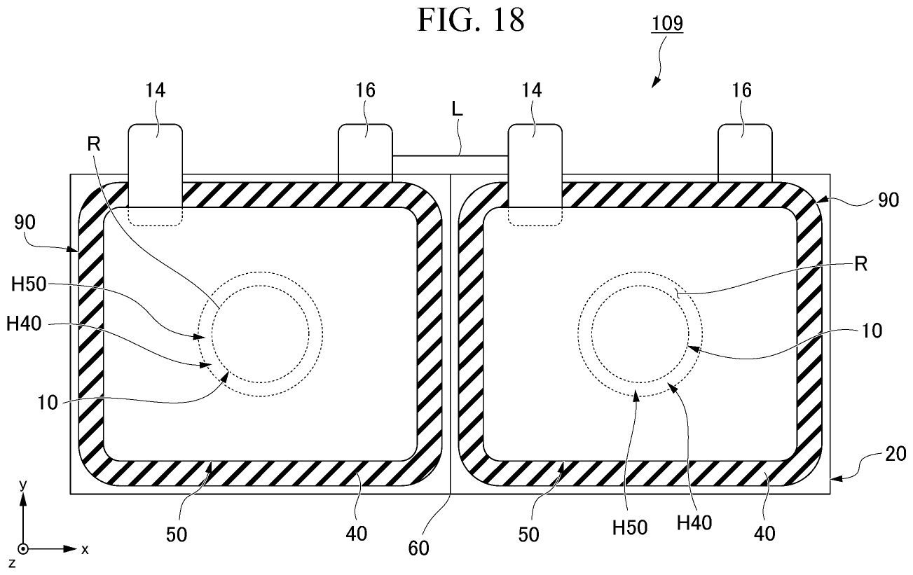

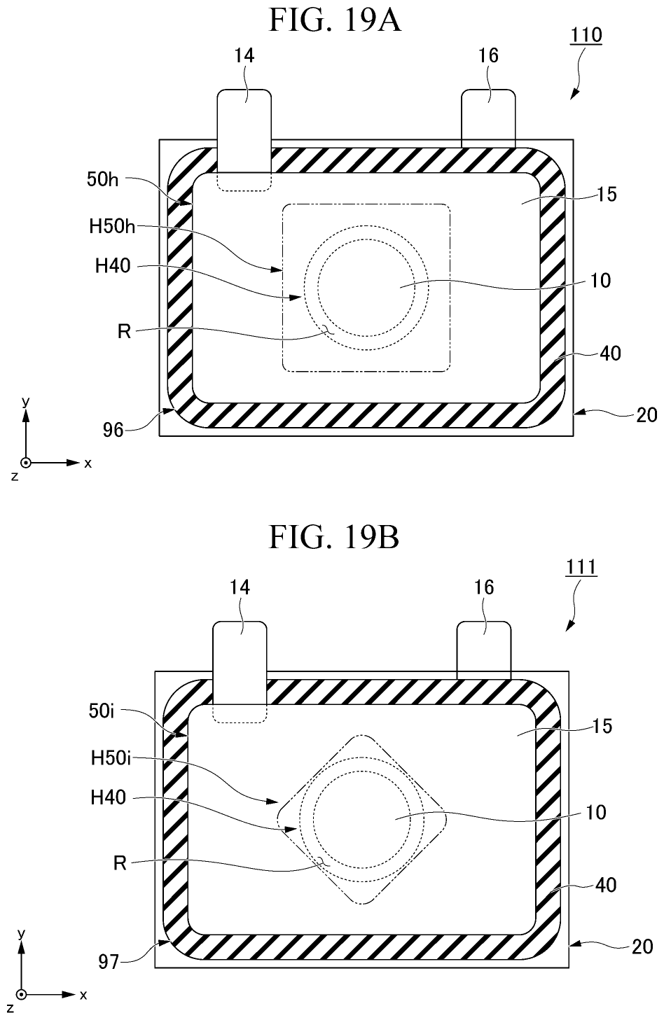

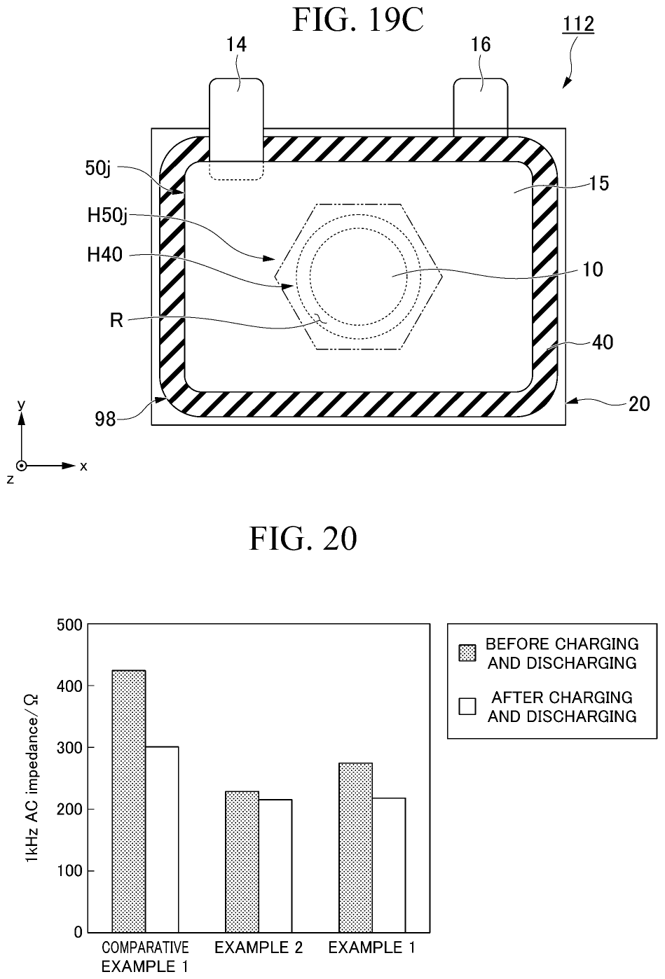

FIGS. 19A, 19B, and 19C are plan views of all-solid-state batteries 110, 111, and 112 according to Modified Example 9. The all-solid-state batteries 110, 111, and 112 are different from the all-solid-state battery 100 in that the first through-holes H50h, H50i, and H50j of the adhesive sheets 50h, 50i, and 50j provided in power storage elements 96, 97, and 98 are not circular.

The shape of the first through-hole H50h in FIG. 19A is rectangular. The shape of the first through-hole H50i in FIG. 19B is rectangular. The shape of the first through-hole H50j in FIG. 19C is hexagonal. In addition, the first through-holes H50h, H50i, and H50j can be arbitrarily selected from a polygonal shape, an elliptical shape, a star shape, an irregular shape, and the like.

The first through-holes H50h, H50i, and H50j may be formed to surround the second through-hole H40 when viewed from the z direction. A part of the first through-holes H50h, H50i, and H50j may or may not be in contact with the second through-hole H40 when viewed from the z direction.

The shape of the first through-holes H50h, H50i, and H50j can be selected depending on the shape of the punching blade.

The all-solid-state batteries 110, 111, and 112 are formed by dividing, for example, the step of forming the first through-holes H50h, H50i, and H50j in the adhesive sheets 50h, 50i, and 50j and the step of forming the second through-hole H40 in the insulating sheet 40.

Even in the all-solid-state batteries 110, 111, and 112, since the adhesive sheets 50h, 50i, and 50j, the insulating sheet 40, and the current collector 15 are in close contact to each other, it is possible to suppress the collision between the insulating sheet 40 and the laminate 10 and to suppress the misalignment and cracking of the laminate 10. Further, since the insulating sheet 40 and the current collector 15 are in close contact with each other via the adhesive sheets 50h, 50i, and 50j even when the powder Z is generated, the gap between the insulating sheet 40 and the current collector 15 is small and the entrance of the powder Z can be suppressed even in a region not provided with the adhesive sheets 50h, 50i, and 50j. That is, it is possible to suppress deterioration in aesthetics or an increase in internal resistance.

Although the embodiments of the present invention have been described above in detail with reference to the drawings, the configurations and combinations thereof in the above-described embodiments are merely examples, and additions, omissions, substitutions, and other changes to the configurations are possible without departing from the gist of the present invention.

### EXAMPLES

Hereinafter, examples of the present invention will be described. The present invention is not limited to the following examples.

### Example 1

The all-solid-state battery shown in FIG. 1 was manufactured as Example 1 and the internal resistance was measured. Specifically, Example 1 was performed using the following procedure.

First, the laminate consisting of the positive electrode current collector/the positive electrode active material layer/the solid electrolyte layer/the negative electrode active material layer/the negative electrode current collector was manufactured by the following powder compaction method.

A lower punch with a diameter of 9.99 mm was inserted into a resin holder having a through-hole with a diameter of 10 mm at the center from below the through-hole. Subsequently, Li₂ZrCl₆ which is a material of a solid electrolyte layer was input from above the through-hole. Subsequently, an upper punch with a diameter of 9.99 mm was inserted from above the through-hole and the material was pressed at a pressure of 5 kN using a pressing machine to form a solid electrolyte layer with a thickness of 0.3 mm.

The upper punch was removed once and an LCO-solid electrolyte mixture that would become the positive electrode active material layer was input. As the LCO-solid electrolyte mixture, powders were used in which 0.7 g, 0.35 g, and 0.03 g of LCO, Li₂ZrCl₆ and carbon black were mixed using an agate mortar, respectively. Subsequently, the mixture was pressed again at a pressure of 5 kN using the pressing machine and the positive electrode active material layer with a thickness of 0.05 mm was formed on the solid electrolyte layer.

The lower punch was removed once and a LTO-solid electrolyte mixture that would become the negative electrode active material layer was input. As the LTO-solid electrolyte mixture, powders were used in which 0.55 g, 0.4 g, and 0.05 g of LTO, Li₂ZrCl₆, and graphite were mixed using an agate mortar, respectively. Subsequently, the mixture was pressed again at a pressure of 5 kN using the pressing machine and a laminate with a thickness of 0.4 mm was formed in which the negative electrode active material layer with a thickness of 0.05 mm was provided below the laminate of the positive electrode active material layer and the solid electrolyte layer.

The insulating sheet and the adhesive sheet were formed by the following method.

Specifically, first, Lumirror H10 (manufactured by Toray Industries, Inc.) which is a PET sheet with a thickness of 100 mm was prepared as an insulating film. Subsequently, a double-sided tape with a thickness of 50 μm and having the same planar shape as the insulating film was bonded as an adhesive sheet to the main surfaces on both sides of the insulating film. As the double-sided tape, HJ-9150W which is a product number and manufactured by Nitto Denko Corporation was used.

Subsequently, the layered structure 45 was manufactured in which a circular through-hole with an inner diameter of 11 mm was formed at the center of the insulating film and the double-sided tape using a Pinnacle blade (Pinnacle is a registered trademark) and an adhesive sheet is provided on both main surfaces of the insulating sheet.

A power storage element was assembled.

First, in each of the positive electrode current collector and the negative electrode current collector, the lead was joined to the outside of the positive electrode current collector and the negative electrode current collector in the laminating direction by ultrasonic welding. As the lead, an aluminum sealant tab was used.

The insulating sheet was bonded to the positive electrode current collector via the adhesive sheet. Subsequently, the laminate was disposed at the through-hole using tweezers. Subsequently, the insulating sheet was bonded to the negative electrode current collector via the adhesive sheet.

The exterior body 20 is heat-sealed except for one opening portion. Then, the remaining opening portion may be heat-sealed while the inside of the exterior body 20 is evacuated. Since the heat-sealing is performed in an evacuated state, the exterior body 20 can be sealed in a state where gas and moisture present in the accommodation space K are small.

The exterior body 20 is sandwiched between metal plates via baking plates, and the four corners of the metal plates are fastened with bolts and nuts to restrain them. Here, as the metal plate, a metal plate whose size in the x direction or the y direction is larger than the exterior body 20 can be used.

The obtained power storage element was accommodated in the exterior body. As the exterior body, an aluminum laminate bag was used.

### (Measurement of Internal Resistance)

The internal resistance before charging and discharging the all-solid-state battery of Example 1 was measured. The internal resistance was measured using BT3563 (manufactured by Hioki Electric Co., Ltd.).

Subsequently, the all-solid-state battery was charged and discharged while applying a pressure using a charger and discharger SD8 (which is a product name and manufactured by Hokuto Denko Co., Ltd.). The pressure of the all-solid-state battery was set to 2 kN. Constant current charging of the all-solid-state battery was performed at 0.05 C until the battery voltage reached 2.8 V, the constant voltage charging thereof was performed until the current density reached 0.01 C, and then constant current discharging was performed at 0.05 C until the battery voltage reached 1.3 V.

The internal resistance of the all-solid-state battery after charging and discharging was measured using the same method as the method used to measure the internal resistance before charging and discharging.

### Example 2

The all-solid-state battery shown in FIGS. 11 and 12 was manufactured as Example 2. That is, this example is different from Example 1 only in that an adhesive sheet is disposed only on one side between an insulating sheet and a positive electrode current collector and a power storage element is fixed by a fixed tape.

As the fixed tape, 650S-25-10X20 (manufactured by Teraoka Seisakusho Co., Ltd.) was used. The fixed tape was disposed on three sides of four sides of the power storage element where the leads 16 and 14 were not located and was disposed to bond the side surface of the insulating sheet 40 and the surface on the side opposite to the laminate 10 in the main surfaces of the positive electrode current collector 15A and the negative electrode current collector 15B.

The internal resistance of the all-solid-state battery of Example 2 before and after charging was measured using the same method as in Example 1.

### Comparative Example 1

As Comparative Example 1, the all-solid-state battery shown in FIGS. 4 and 5 was manufactured. That is, this example is different from Example 2 only in that a power storage element is fixed only by a fixed tape without using an adhesive sheet.

The internal resistance of the all-solid-state battery of Comparative Example 1 before and after charging was measured using the same method as in Example 1.

FIG. 20 shows the measurement results of the internal resistances of the all-solid-state batteries of Examples 1 and 2 and Comparative Example 1. It was confirmed that the all-solid-state batteries of Examples 1 and 2 had a lower internal resistance than the all-solid-state battery of Comparative Example 1 both before and after charging and discharging. This is because the laminate and the current collector are in close contact with each other due to the adhesive sheet provided in at least one of between the insulating sheet and the positive electrode current collector and between the insulating sheet and the negative electrode current collector.

When observing the appearance of the all-solid-state batteries of Examples 1 and 2 and Comparative Example 1, it was confirmed that the powder generated by the chipping of the laminate entered between the current collector and the insulating sheet in the overlapping region of the current collector and the laminating direction in the all-solid-state battery of Comparative Example 1. On the other hand, it was confirmed that no unevenness was observed due to the powder even when observing the appearance and the powder was suppressed from entering between the insulating sheet and the current collector due to the cracking of the laminate in the all-solid-state battery of Examples 1 and 2.

Furthermore, in this example, when comparing Examples 1 and 2, Example 2 had a lower internal resistance than Example 1. However, since the all-solid-state battery of Example 1 has the adhesive sheets on both surfaces of the insulating sheet, the insulating sheet and the current collector are bonded without any gap therebetween, and both sides of the adhesive sheets act as a barrier, it is presumed that the powder is less likely to enter between the insulating sheet and the current collector compared to the all-solid-state battery of Example 2 and the internal resistance tends to be smaller than Example 2.

### INDUSTRIAL APPLICABILITY

According to the present invention, it is possible to provide the all-solid-state battery capable of suppressing the misalignment, cracking, and short circuits of the laminate and having a low internal resistance.

### REFERENCE SIGNS LIST

10 Laminate
11 Positive electrode active material layer
12 Solid electrolyte layer
13 Negative electrode active material layer
15A Positive electrode current collector
15B Negative electrode current collector
15 Current collector
20 Exterior body
40 Insulating sheet
50 Adhesive sheet
50A First adhesive sheet
50B Second adhesive sheet
51, 52, 53 Fixed tape
90 Power storage element
100 All-solid-state battery
H40 Second through-hole
H50 First through-hole

1. An all-solid-state battery comprising:
a laminate in which a positive electrode active material layer, a solid electrolyte layer, and a negative electrode active material layer are laminated in this order;
a positive electrode current collector and a negative electrode current collector which sandwich the laminate in a laminating direction;
an insulating sheet which surrounds the laminate between the positive electrode current collector and the negative electrode current collector; and
a first adhesive sheet which bonds the insulating sheet and the positive electrode current collector or the insulating sheet and the negative electrode current collector,
wherein a first through-hole is formed in the first adhesive sheet, and
wherein the laminate is accommodated in the first through-hole when viewed from the laminating direction of the laminate.

2. The all-solid-state battery according to claim 1, further comprising:
a second adhesive sheet,
wherein the second adhesive sheet bonds the insulating sheet and the positive electrode current collector or the second adhesive sheet bonds the insulating sheet and the negative electrode current collector in a surface opposite to a surface contacting the first adhesive sheet in the insulating sheet.

3. The all-solid-state battery according to claim 1,
wherein a gap between the positive electrode current collector and the negative electrode current collector in a region overlapping the first adhesive sheet is smaller than a gap between the positive electrode current collector and the negative electrode current collector in a region overlapping the laminate.

4. The all-solid-state battery according to claim 1,
wherein a second through-hole is formed in the insulating sheet,
wherein the laminate is accommodated in the second through-hole when viewed from the laminating direction of the laminate, and
wherein the first through-hole has a shape similar or congruent with that of the second through-hole.

5. The all-solid-state battery according to claim 1,
wherein a second through-hole is formed in the insulating sheet,
wherein the laminate is accommodated in the second through-hole when viewed from the laminating direction of the laminate, and
wherein an inner dimension of the first through-hole is equal to or larger than an inner dimension of the second through-hole.

6. The all-solid-state battery according to claim 1, further comprising:
an adhesive tape,
wherein the adhesive tape includes a first portion which contacts a surface on the side opposite to a surface contacting the laminate in the positive electrode current collector, a second portion which contacts a surface on the side opposite to a surface contacting the laminate in the negative electrode current collector, and a third portion which connects together the first portion and the second portion.
